(19) United States
(12) Patent Application Publication
(10) Pub. No.: US 2026/0034773 A1
(43) Pub. Date: Feb. 5, 2026

(54) DECORATIVE ENGINEERED SURFACE

(71) Applicant: Wilsonart LLC, Austin, TX (US)

(72) Inventors: Mahesh Subramanian, Centerville, OH (US); Rajesh Ramamurthy, Temple, TX (US); Arvind S. Karthikeyan, Temple, TX (US)

(21) Appl. No.: 19/286,950

(22) Filed: Jul. 31, 2025

Related U.S. Application Data
(60) Provisional application No. 63/678,346, filed on Aug. 1, 2024.

(51) Int. Cl. B32B 27/10; B32B 29/00

(52) U.S. Cl. CPC B32B 27/10; B32B 29/005; B32B 2250/03; B32B 2250/20; B32B 2255/26; B32B 2260/023; B32B 2260/046; B32B 2305/72; B32B 2307/412; B32B 2307/7376; B32B 2307/75

(57) ABSTRACT

A decorative engineered surface having a has a thickness of 0.50 mm to 1.00 mm includes a core layer and a decorative layer.

### CROSS-REFERENCE TO RELATED APPLICATIONS

The present application claims the benefit of U.S. Patent Application Ser. No. 63/678,346, entitled “DECORATIVE ENGINEERED SURFACE,” filed Aug. 1, 2024, which is incorporated herein by reference.

### BACKGROUND OF THE INVENTION

### 1. Field of the Invention

The present invention relates to decorative engineered surfaces.

### 2. Description of the Related Art

High pressure decorative laminates prepared by heat and pressure consolidation have been produced commercially for a number of years, and have found widespread acceptance in the building and furniture industry as counter and tabletops, bathroom and kitchen work surfaces, wall paneling, flooring products, partitions, and doors.

High pressure decorative laminates generally include plural layers of synthetic resin impregnated paper sheets bonded under heat and pressure to form a unitary structure. In normal practice, a decorative laminate sheet assembly, from the bottom up, includes a core of one or more phenolic resin impregnated sheets, above which lies a decorative melamine impregnated sheet. The decorative sheet may be further covered with a melamine impregnated overlay. The core, or base, functions to impart rigidity to the decorative laminate and usually includes a solid substrate which may, or may not, be formed prior to the initial laminating steps. Prior to stacking, the sheets of the core member are impregnated with a water alcohol solution of phenol formaldehyde, dried and partially cured in a hot oven, and finally cut into shapes.

The core may, for example, include a plurality of sheets of 90-150 pound phenolic resin impregnated Kraft paper and a substrate. The Kraft paper is impregnated throughout and bonded with a substantially completely cured phenolic resin which has been converted to a thermoset state during the initial laminating step. The substrate may be a pre-cured plastic laminate, such as glass fiber-reinforced thermoset polyester resin laminates and the like, a wood product, such as hardboard, wood waste or particle boards, plywood and the like, a mineral base board, such as, cement-asbestos board, sheet rock, plaster board, and the like, or a combination of substrates.

However, the world of decorative surfacing materials is constantly evolving to provide consumers with cutting-edge technologies to meet both their aesthetic desires and functional needs. Meeting both the aesthetic desires and functional needs of consumers forces engineers and scientists within the industry to constantly evaluate the current needs of society and address these needs with real-world products. The present invention provides a decorative engineered surface that advances the industry by providing a durable, customizable, environmentally friendly, sustainable, and cost-effective surfacing material.

### SUMMARY OF THE INVENTION

In one aspect a decorative engineered surface having a has a thickness of 0.50 mm to 1.00 mm comprises a core layer and a decorative layer.

In some embodiments the decorative layer comprises melamine impregnated decorative paper, real wood veneer, thin slate, metallics, digitally printed surface, foils, or polyurethane and other lacquered surfaces.

In some embodiments the core layer comprises a vulcanized sheet.

In some embodiments the decorative surfacing defining the decorative layer comprises digital printing.

In some embodiments the decorative layer further comprises a topcoat layer.

In some embodiments the topcoat layer comprises a melt polyurethane layer followed by a clear UV cured acrylic coating layer.

In some embodiments the topcoat layer is an epoxy acrylate resin.

In some embodiments the vulcanized sheet comprises a priming layer.

In some embodiments the decorative engineered surface further includes an overlay layer positioned over the decorative layer.

In some embodiments the overlay layer comprises a melamine impregnated paper layer.

In some embodiments the decorative layer comprises a decorative sheet positioned directly beneath the overlay layer.

In some embodiments the decorative sheet comprises pigment filled, alpha cellulose paper impregnated with a water alcohol or water solution of melamine-formaldehyde resin.

In some embodiments the decorative sheet comprises unimpregnated pigment filled, alpha cellulose paper.

In some embodiments the core layer comprises plural sheets of liner kraft paper.

In some embodiments the liner kraft paper is impregnated with a non phenolic resin.

In some embodiments the resin is an epoxy acrylic or a urethane acrylic.

In some embodiments the decorative layer comprises a resin impregnated decorative sheet and the core layer comprises a single sheet of resin impregnated liner kraft paper.

In some embodiments the resin impregnated liner kraft paper has a basis weight of approximately 400 grams per square meter.

In some embodiments the liner kraft paper is impregnated with an epoxy acrylic or a urethane acrylic.

In some embodiments the epoxy acrylic or a urethane acrylic is applied to only a bottom surface of the liner kraft paper.

In some embodiments the core layer comprises a single sheet of resin impregnated liner kraft paper.

Other objects and advantages of the present invention will become apparent from the following detailed description when viewed in conjunction with the accompanying drawings, which set forth certain embodiments of the invention.

### BRIEF DESCRIPTION OF THE DRAWINGS

Aspects of the present disclosure are illustrated by way of example and are not limited by the accompanying figures with like reference numbers indicating like elements.

FIG. 1 is a schematic of a decorative engineered surface in accordance with the first embodiment.

FIGS. 2, 3, and 4 are schematics showing the various steps in the assembly of the decorative engineered surface shown in FIG. 1.

FIG. 5 is a schematic of a decorative engineered surface in accordance with a second embodiment.

FIGS. 6 and 7 are schematics showing the various steps in the assembly of the decorative engineered surface shown in FIG. 5.

FIG. 8 is a schematic of a decorative engineered surface in accordance with a third embodiment.

FIGS. 9 and 10 are schematics showing the various steps in the assembly of the decorative engineered surface shown in FIG. 8.

FIG. 11 is a schematic of a decorative engineered surface in accordance with a fourth embodiment.

FIGS. 12 and 13 are schematics showing the various steps in the assembly of the decorative engineered surface shown in FIG. 11.

FIG. 14 is a schematic of a decorative engineered surface in accordance with a fourth embodiment.

FIGS. 15, 16, and 17 are schematics showing the various steps in the assembly of the decorative engineered surface shown in FIG. 14.

### DETAILED DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

Referring to the various embodiments, the present invention provides a new outlook on decorative surface materials. The decorative engineered surfaces of the present invention each include a core layer and a decorative layer, but allow for versatility in the construction of decorative engineered surface to optimize performance and cost, while simultaneously reducing the carbon footprint associated with the manufacture of the decorative engineered surfaces.

Studies have revealed that by replacing either, or both, resin impregnated decorative sheets and resin impregnated core layer sheets of a decorative laminate, steep reductions in the carbon footprint are achieved. For example, resin impregnating of resin impregnated decorative paper, resin impregnated liner kraft paper used in the core of traditional laminates, and resin impregnated overlay paper require the use of energy intensive boilers, regenerative thermal oxidizers (RTO), and phenolic treaters. With the elimination or modification of boilers, regenerative thermal oxidizers, and phenolic treaters, a 30% to 55% reduction is achieved in carbon intensity associated with the manufacture of high pressure decorative laminates. In particular, boilers produce a substantial amount of heat and 45% of boiler heat is wasted. Regenerative thermal oxidizers and phenolic treaters also produce substantial energy drains on the systems used to produce high pressure decorative laminates.

Further, and considering the replacement of decorative paper with direct printing on laminates, one may achieve a 35% overall reduction in carbon intensity. For example, the elimination of phenolic treating results in a 9% reduction in carbon intensity, the elimination of melamine treating results in a 6% carbon intensity reduction, and the elimination of pressing results in a 35% carbon intensity reduction. Further reductions in global impact are achieved by the utilization of 100% PCR (Post-Consumer Recycled) SAT (Saturating) liner kraft paper, the utilization of modified resins, and the utilization of digital printing.

The present invention applies innovative techniques to improve the production of decorative surfaces and reduce the environmental impact of current manufacturing techniques.

Regardless of the specific construction contemplated in accordance with the various embodiments, each of the decorative engineered surfaces has a thickness of 0.50 mm (millimeter) to 1.00 mm (millimeter). As the following embodiments disclose, the decorative layer may take the form of melamine impregnated decorative paper, real wood veneer, thin slate, metallics, digitally printed surface (that may or may not be coated with various surfacing coatings), foils, as well as polyurethane and other lacquered surfaces.

Ultimately, the present invention contemplates the ability to produce decorative engineered surfaces specifically suited for the purpose at hand. Considerations regarding durability, aesthetics, intended use, anticipated length of use, etc. are considered in the construction of the decorative engineered surface.

### Embodiment 1

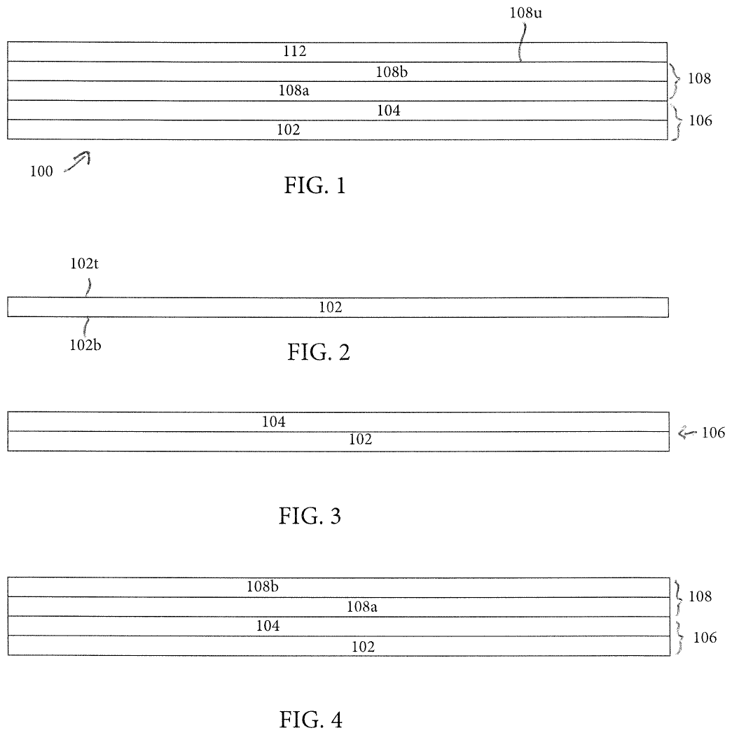

In accordance with a first embodiment, as shown with reference to FIGS. 1-4, the decorative engineered surface 100 makes use of a core layer 102 comprised of a vulcanized sheet. This embodiment relies upon a combination of digital printing and various coatings used in conjunction with a core layer of vulcanized fiber to produce a durable, cost-effective, and aesthetically pleasing decorative engineered surface.

As briefly mentioned above, the decorative engineered surface 100 includes a core layer 102 of vulcanized fiber. Because of the inherent characteristics of the vulcanized fiber core layer 102, no pretreatment is required as the vulcanized fiber core layer 102 is highly receptive to digital printing using UV (ultraviolet) inks. It is also appreciated that water-based inks can also be used, although the clarity may not be as good as that achieved with UV inks. The decorative surfacing 104 is, therefore, applied to vulcanized fiber core layer 102 by digital printing (using conventional digital printing techniques) to produce a printed core layer 106 that combines the characteristics of the core layer 102 (that is, the vulcanized fiber core layer) with the decorative surfacing 104 (that is, the digitally printed surface the is ultimately protected by a topcoat layer as discussed below).

The utilization of a vulcanized core layer 102 on which the decorative surfacing 104 is directly printed results in substantial decrease in environmental impact when one considers such a manufacturing technique no longer requires boilers, regenerative thermal oxidizer (RTO), and phenolic treaters. The decorative engineered surface 100 also eliminates the energy required to press traditional high pressure decorative laminate.

The topcoat layer 108 is applied to the printed vulcanized fiber core layer 106 to provide scratch resistance and other physical properties. In accordance with a preferred embodiment, and as will be discussed below in greater detail, the topcoat layer 108 includes a clear hot melt polyurethane first topcoat layer 108a followed by a clear UV cured acrylic second topcoat layer 108b.

As those skilled in the art will appreciate, vulcanized fiber sheets are laminated plastics composed of cellulose. The cellulose is processed to produce durable, thin, and inexpensive sheets that are used in accordance with the present invention. Vulcanized fiber sheets are typically formed from a cotton base that has been partially gelatinized by dissolving some of the cotton cellulose with an acid, such as a Bronsted acid (e.g., sulfuric acid) or a Lewis acid (e.g., zinc chloride). The excess acid is then leached out of the fiber, and the gelatinized fiber base is pressed together with other plies of cellulose treated in a similar manner to form a multiple-ply product referred to in the industry as a “Vulcanized Fiber Sheet.” In particular, once the fiber is leached substantially free of the acid, it is dried to a moisture content of 5 to 6 percent and pressed to a desired thickness. Where a continuous process is employed, the vulcanized fiber is sheeted or wound up into rolls for use in accordance with the decorative engineered surface 100. The density of the finished vulcanized fiber is 2 to 3 times greater than the cellulose from which it starts. The density increase is the result of 10% machine direction shrinkage, 20% cross machine direction shrinkage, and 30% shrinkage in thickness. In accordance with a preferred embodiment, the decorative engineered surface 100 will employ conventional, off the shelf vulcanized fibers.

With reference to the embodiment disclosed with reference to FIGS. 1 to 4, the manufacture of a decorative engineered surface 100 is disclosed. After the top and bottom surfaces 102t, 102b of a vulcanized fiber core layer 102 are brushed clean, the top surface 102t of the vulcanized fiber core layer 102 is digitally printed with UV-curable inks of various colors. As discussed above, water-based inks may also be used, and where it is desired to use water-based inks, it may be advantageous to treat the vulcanized fiber core layer 102 with a priming layer to prepare the vulcanized fiber substrate for printing with the water-based inks.

The vulcanized fiber core layer 102 is printed digitally using a scanning or single-pass digital printer. As discussed above, UV-curable inks or water-based inks may be used. Where UV-curable inks are employed, the printing is followed by UV curing as is known in the art. Where water-based inks are employed, the printing is followed by a drying process as is known in the art.

Once the vulcanized fiber core layer is printed, that is, the printed core layer 106 is formed, a topcoat layer 108 is applied over the UV-curable inks, that is, the topcoat layer 108 is applied to an upper surface of the printed core layer 106.

The topcoat layer 108 in accordance with one embodiment includes a first topcoat layer 108a of clear hot melt polyurethane and a second topcoat layer 180b of clear UV cured acrylic. The coat weight of the clear hot melt polyurethane first topcoat layer 108a determines various functional characteristics of the final product, and these characteristics are ultimately balanced in determining the coat weight of the clear hot melt polyurethane first topcoat layer 108a applied to the printed vulcanized fiber core layer 106. In particular, increased coat weight will result in improved impact resistance and an increased resistance to abrasion. It is also appreciated that the hot melt polyurethane may contain aluminum oxide to enhance wear and scratch resistance.

After the application and initial setting of the clear hot melt polyurethane first topcoat layer 108a to the printed vulcanized fiber core layer 106, a clear UV-cured acrylic second topcoat layer 108b is applied to the clear hot melt polyurethane first topcoat layer 108a. The resulting product is fully cured, and a protective film 112 is applied to the upper surface 108u thereof so as to cover the topcoat layer 108. The decorative engineered surface 100 is then ready for use.

In accordance with another embodiment, the topcoat is an epoxy acrylate (EA) resin 108′. Such resins are known to exhibit good integrated performance such as outstanding adhesion, non-yellowing, hardness, mechanical properties, and chemical resistance. Where epoxy acrylate resins are used, the epoxy acrylate resin can be extended by epoxidized oil and/or Lignin derivatives of Eugenol.

The decorative engineered surface 100 described above may be secured to other substrates where greater support and rigidity are desired. For example, substrates to which the decorative surfacing material of the present invention may be secured include a pre-cured plastic laminate, such as glass fiber-reinforced thermoset polyester resin laminates and the like; polyvinyl chloride materials; polyolefinic materials; wood products, such as hardboard, wood waste or particle boards, plywood and the like; mineral-based boards, such as, cement-asbestos board, sheetrock, plasterboard, and the like; or a combination of substrates.

It is also appreciated that texturing may be applied to the decorative surfacing material via the application of a textured layer to the top surface of the vulcanized fiber core layer prior to printing. Thereafter, printing, the topcoat layer, and the protective films are applied as discussed above. Where texturing is desired, such a texturing layer is applied prior to printing and preferably in a manner as disclosed in U.S. Pat. No. 9,199,428, entitled “MULTI-LAY ADDITIVE TEXTURE LAMINATES AND METHODS,” which is incorporated herein by reference. Briefly, the methodology of the '428 patent provides for the production of a multi-layer additive texture high-definition image. The method requires constructing a build layer, wherein the build layer is comprised of one or more build levels, and each of the build levels includes a surface having one or more heights. The heights are varied in correspondence with an image that is to be subsequently printed upon the primed and textured core layer. By layering in this manner, a three-dimensional textured surface is achieved.

The methodology of the '428 patent employs computers in implementing the method for creating high-definition textured surfacing material. In accordance with this element of the methodology of the '428 patent, a surfacing material image is received and a build value is assigned to each of the one or more image properties in the surfacing material image. The build values relate to a texture, specific to the surfacing material image. These build values are applied in the creation of the build layer discussed above.

### Embodiment 2

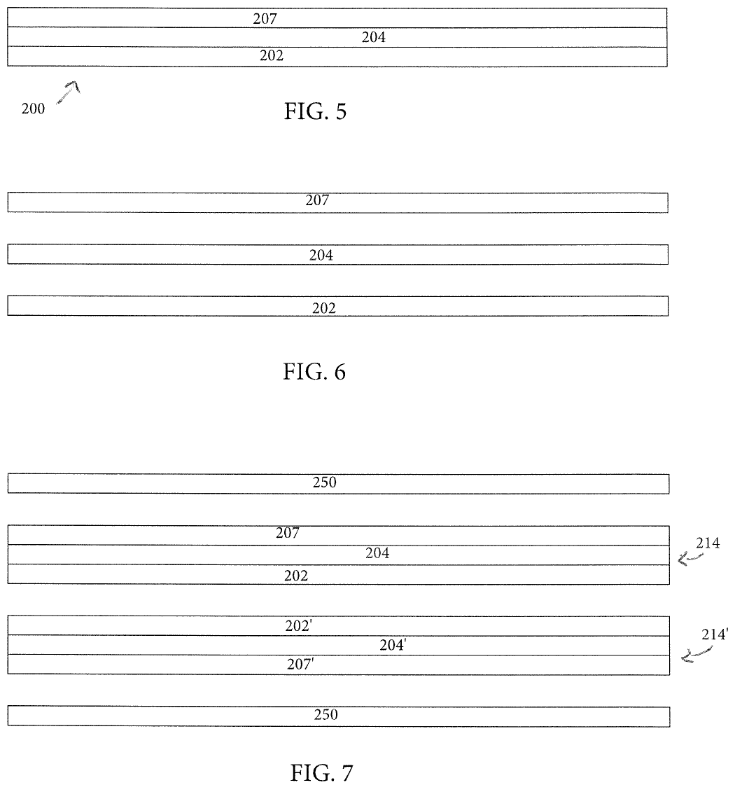

In accordance with another embodiment, as shown with reference to FIGS. 5-7, the decorative engineered surface 200 includes an overlay layer 207, a decorative layer 204, and a core layer 202. The decorative layer 204 is comprised of a resin impregnated decorative sheet. The core layer 202 is comprised of a vulcanized fiber core layer. While a disclosed embodiment includes an overlay layer 207, a decorative layer 204, and a vulcanized fiber core layer 202, it is appreciated that the layering pattern may be varied, somewhat, without departing from the spirit of the present disclosure. For example, it is appreciated that the overlay layer could be removed in the event the intended function of the surfacing allows for its removal.

By replacing the phenolic resin impregnated core layer 202, steep reductions in the carbon footprint are achieved. For example, resin impregnating of core resin impregnated paper requires the use of energy intensive boilers, regenerative thermal oxidizer (RTO), and phenolic treaters. With the elimination of modification of boilers, regenerative thermal oxidizers, and phenolic treaters, a 30% to 55% reduction is achieved in carbon intensity associated with the manufacture of high pressure decorative laminates. In particular, boilers produce a substantial amount of heat and 45% of boiler heat is wasted. Regenerative thermal oxidizers and phenolic treaters also produce substantial energy drains on the systems used to produce high pressure decorative laminates.

As those skilled in the art will appreciate, vulcanized fiber sheets are laminated plastics composed of cellulose. The cellulose is processed in a manner well known to those skilled in the art to produce durable, thin, and inexpensive sheets that are used in accordance with the present invention. Vulcanized fiber sheets are typically formed from a cotton base that has been partially gelatinized by dissolving some of the cotton cellulose with an acid, such as a Bronsted acid (e.g., sulfuric acid) or a Lewis acid (e.g., zinc chloride). The excess acid is then leached out of the fiber, and the gelatinized fiber base is pressed together with other plies of cellulose treated in a similar manner to form a multiple-ply product referred to in the industry as a “Vulcanized Fiber Sheet.” In particular, once the fiber is leached substantially free of the acid, it is dried to a moisture content of 5 to 6 percent and pressed to a desired thickness. Where a continuous process is employed, the vulcanized fiber is sheeted or wound up into rolls for use in accordance with the present invention. The density of the finished vulcanized fiber is 2 to 3 times greater than the cellulose from which it starts. The density increase is the result of 10% machine direction shrinkage, 20% cross machine direction shrinkage, and 30% shrinkage in thickness. In accordance with a preferred embodiment, the present invention will employ conventional, off the shelf vulcanized fibers.

The overlay layer 207 is preferably a melamine impregnated paper layer. The overlay layer 207 is preferably manufactured from a low basis weight transparent sheet impregnated with resin, for example, melamine. The resin impregnated overlay layer 207 is subsequently dried, partially cured, and finally cut into sheets. While the paper may exhibit opaque properties prior to heating and pressing, the overlay layer 207 in the final fabricated decorative engineered surface is preferably transparent to permit viewing of the decorative sheet positioned directly beneath the overlay layer 207.

The decorative layer 204 is comprised of a conventional decorative sheet positioned directly beneath the overlay layer 207. When the decorative engineered surface 200 is fully heated and pressed, as will be discussed in detail below, the overlay layer 207 becomes translucent, fully exposing the decorative layer 204. The decorative layer 204 is chosen from a wide array of sheets. For example, the decorative layer 204 may be a solid color (for example, white) or may include an aesthetically appealing pattern.

The overlay layer 207 and the decorative layer 204 also dictate the surface characteristics of the final decorative engineered surface 200. For example, the composition of the overlay layer 207 and decorative layer 204 dictates the decorative engineered surface's resistance to chemical agents, heat, light, shock, and abrasion.

As discussed above, the decorative layer 204 is comprised of a sheet of decorative paper. The decorative paper may be treated with resin or left untreated.

As to the situation where the decorative sheet is treated with a resin, the decorative sheets are commonly manufactured from high quality 60-205 grams/meter², pigment filled, alpha cellulose paper impregnated with a water alcohol or water solution of melamine-formaldehyde resin. The decorative paper, in accordance with an embodiment of the present disclosure, is impregnated with a resin content of approximately 50% or greater. The resin impregnated decorative sheets are subsequently dried, partially cured, and finally cut into sheets. The pigment filled, alpha cellulose paper of the decorative sheet may include a solid color, a decorative design, or a roto-gravure reproduction of natural materials, such as, wood, marble, leather, etc. The aesthetic characteristics of the cellulose paper are revealed as the decorative engineered surface's decorative design upon completion of the decorative engineered surface.

As to the situation where the decorative sheet is untreated, the decorative layer 204 is comprised of a sheet of decorative paper manufactured from high quality 60-205 grams/meter², pigment filled, alpha cellulose paper. The pigment filled, alpha cellulose paper of the decorative sheet may include a solid color, a decorative design, or a roto-gravure reproduction of natural materials, such as, wood, marble, leather, etc. The aesthetic characteristics of the cellulose paper are revealed as the decorative engineered surface's decorative design upon completion of the decorative engineered surface.

The core layer 202 is a vulcanized fiber core layer as described above.

Once the appropriate layers of the decorative engineered surface 200 are formed, the sheets are stacked in a conventional manner. A first laminate lay-up 214 is then stacked with a second laminate lay-up 214′ with the second sides of the bottom second resin impregnated core layers 202, 202′ sheets positioned in a facing relationship. The first and second laminate lay-ups 214, 214′, are then placed between steel press plates 250 with the overlay layers 207, 207′ of the respective first laminate lay-up 214 and the second laminate lay-up 214′ in direct contact with the steel press plates 250. The laminate lay-ups 214, 214′ are then subjected to temperatures in the range of 121° C.-160° C., preferably 131° C., and pressure of about 56.24 kg/cm²-112.48 kg/cm², preferably 85 kg/cm² for a time sufficient to consolidate the decorative engineered surface 200 and cure the resins (generally about 25 minutes to an hour). The decorative engineered surfaces 200, 200′ are then cooled for approximately 10 minutes under pressure before they are ready for further processing in preparation for its use in the manufacture of various products.

While specific temperatures, pressures and times are described above, it should be appreciated that a variety of pressing techniques may be used without departing from the spirit of the present disclosure.

The pressure and heat force the resin in the paper sheets to flow, cure and consolidate the sheets into a unitary laminated mass referred to in the art as a decorative high pressure laminate. Generally, more than one decorative engineered surface is formed at one time.

### Embodiment 3

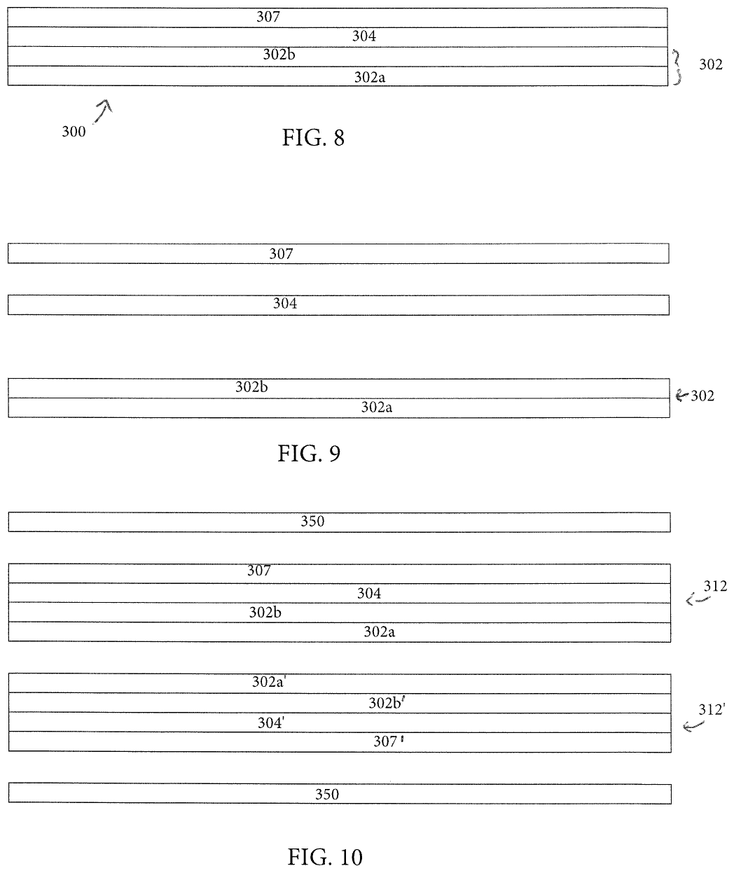

In accordance with yet another embodiment, as shown with reference to FIGS. 8-10, the decorative engineered surface 300 includes an overlay layer 307, a decorative layer 304, and a core layer 302. While a disclosed embodiment includes an overlay layer, a decorative layer, and a core layer, it is appreciated that the layering pattern may be varied, somewhat, without departing from the spirit of the present disclosure. For example, it is appreciated that the overlay layer could be removed in the event the intended function of the surfacing allows for its removal.

The core layer 302 is comprised of plural sheets of liner kraft paper 302a, 302b, which is, broadly speaking, a very heavy basis weight sheet of liner kraft approximately 400 grams per square meter (also referred to herein as “gsm” or “grams/meter²”). In accordance with a disclosed embodiment, the core layer includes 2 sheets of the liner kraft paper 302a, 302b. As will be explained below in more detail, the liner kraft paper 302a, 302b is impregnated with a resin. Using a non phenolic resin is mandatory to treat these super heavy layers. Additives could be used if 2 sheets are used to get them to stick to each other.

The replacement of traditional kraft paper with liner kraft paper 302a, 302b offers a number of advantages that include both purely commercial benefits and environmental benefits reducing the carbon footprint associated with the production of surfacing materials. As those skilled in the art can appreciate liner kraft paper differs from traditional kraft paper in that it does not saturate with resin in the same manner that traditional kraft paper saturates with resin. This characteristic of liner kraft will require the creation of a resin system capable of impregnating liner and grade kraft during the paper making process, the replacement offers a number of advantages, including the fact that such and embodiment will eliminate the dependency on saturating kraft manufacturers, allows will smart to source from the commodity liner kraft market, potentially eliminates the phenolic treating process at Wilsonart, and potentially eliminate formaldehyde based phenolic resins. In addition, the replacement of traditional kraft paper with liner kraft paper will result in the potential for the closure of phenolic treating and collation, which is known to have a high environmental impact and requires a substantial number of workers to ensure proper processing.

The decorative engineered surface 300 is manufactured by first preparing the resin impregnated decorative layer 304 and the liner kraft paper 302a, 302b. The resin impregnated decorative layer 304 and resin impregnated core sheets 302a, 302b are layered to form a laminate lay-up 312, and the laminate lay-up 312 is heated and pressed to consolidate and cure the decorative engineered surface 300.

In accordance with an embodiment of the present disclosure, the decorative engineered surface 300 includes an overlay layer 307, a decorative layer 304, and a core layer 302 comprised of two liner kraft paper sheets 302a, 302b. It should be appreciated, however, that the layering pattern may be varied, somewhat, without departing from the spirit of the present disclosure.

The overlay layer 307 is preferably a melamine impregnated paper layer. The overlay layer 307 is preferably manufactured from a low basis weight transparent sheet impregnated with resin, for example, melamine. The resin impregnated overlay layer 307 is subsequently dried, partially cured and finally cut into sheets. While the paper may exhibit opaque properties prior to heating and pressing, the overlay layer 307 in the final fabricated decorative engineered surface 300 is preferably transparent to permit viewing of the decorative layer 304 positioned directly beneath the overlay layer 307.

The decorative layer 304 is comprised of a conventional decorative sheet positioned directly beneath the overlay layer 307. When the decorative engineered surface 300 is fully heated and pressed, as will be discussed in detail below, the overlay layer 307 becomes translucent, fully exposing the decorative layer 304. The decorative layer 304 is chosen from a wide array of sheets. For example, the decorative layer 304 may be a solid color (for example, white) or may include an aesthetically appealing pattern.

The overlay layer 307 and the decorative layer 304 also dictate the surface characteristics of the final decorative engineered surface 300. For example, the composition of the overlay layer 307 and decorative layer 404 dictate the decorative engineered surface's resistance to chemical agents, heat, light, shock, and abrasion.

As discussed above, the decorative layer 304 is comprised of a sheet of decorative paper. The decorative paper may be treated with resin or left untreated.

As to the situation where the decorative sheet is treated with a resin, the decorative sheets are commonly manufactured from high quality 60-205 grams/meter², pigment filled, alpha cellulose paper impregnated with a water alcohol or water solution of melamine-formaldehyde resin. The decorative paper, in accordance with an embodiment of the present disclosure, is impregnated with a resin content of approximately 50% or greater. The resin impregnated decorative sheets are subsequently dried, partially cured, and finally cut into sheets. The pigment filled, alpha cellulose paper of the decorative sheet may include a solid color, a decorative design, or a roto-gravure reproduction of natural materials, such as, wood, marble, leather, etc. The aesthetic characteristics of the cellulose paper are revealed as the decorative engineered surface's decorative design upon completion of the decorative engineered surface.

As to the situation where the decorative sheet is untreated, the decorative layer 304 is comprised of a sheet of decorative paper manufactured from high quality 60-205 grams/meter², pigment filled, alpha cellulose paper. The pigment filled, alpha cellulose paper of the decorative sheet may include a solid color, a decorative design, or a roto-gravure reproduction of natural materials, such as, wood, marble, leather, etc. The aesthetic characteristics of the cellulose paper are revealed as the decorative engineered surface's decorative design upon completion of the decorative engineered surface.

The core layer 302 is preferably comprised of liner kraft paper 302a, 302b. In accordance with a disclosed embodiment, the core layer 302 includes two sheets of the liner kraft paper 302a, 302b. The disclosed liner kraft paper has a very heavy basis weight sheet of approximately 400 gsm. Using a non phenolic resin is mandatory to treat these super heavy layers. Additives could be used if 2 sheets are used to get them to stick to each other. The liner kraft paper 302a, 302b is impregnated with an epoxy acrylic or a urethane acrylic (also referred to herein as the acrylate mixture). The impregnating resin may include additives that enhance the ability of the sheets of liner kraft paper to stick together.

Once the appropriate layers of the decorative engineered surface are formed, the sheets are stacked in a conventional manner. A first laminate lay-up 312 as described above is then stacked with a second laminate lay-up 312′ with the second sides of the bottom second resin impregnated core layers 302, 302′ positioned in a facing relationship. The first and second laminate lay-ups 312, 312′ are then placed between steel press plates 350 with the overlay layers 307, 307′ of the respective first laminate lay-up 312 and the second laminate lay-up 312 in direct contact with the steel press plates 350. The laminate lay-ups are then subjected to temperatures in the range of 121° C.-160° C., preferably 131° C., and pressure of about 56.24 kg/cm²-112.48 kg/cm², preferably 85 kg/cm² for a time sufficient to consolidate the laminate and cure the resins (generally about 25 minutes to an hour). The decorative engineered surfaces 300, 300′ are then cooled for approximately 10 minutes under pressure before it is ready for further processing in preparation for its use in the manufacture of various products.

While specific temperatures, pressures and times are described above, it should be appreciated that a variety of pressing techniques may be used without departing from the spirit of the present disclosure.

The pressure and heat force the resin in the paper sheets to flow, cure and consolidate the sheets into a unitary laminated mass referred to in the art as a decorative high pressure laminate. Generally, more than one decorative engineered surface is formed at one time.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by appended claims.

### Embodiment 4

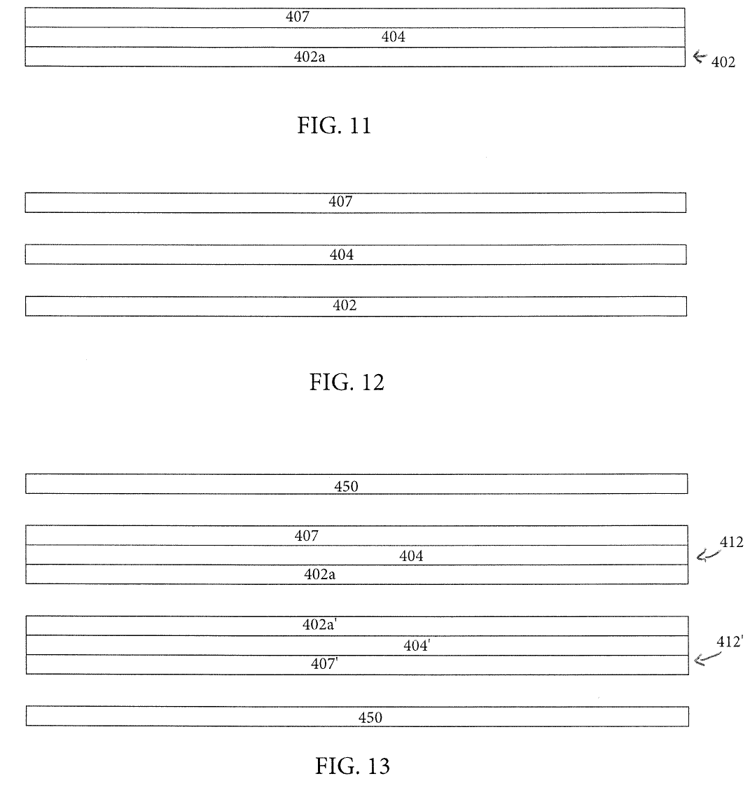

In accordance with yet another embodiment, as shown with reference to FIGS. 11-13, the decorative engineered surface 400 includes an overlay layer 407, a decorative layer 404, and a core layer 402. The decorative layer 404 is comprised of a resin impregnated decorative sheet. The core layer 402 is comprised of a single sheet of resin impregnated liner kraft paper 402a, which is, a liner kraft paper having a very heavy basis weight of approximately 400 gsm. While a disclosed embodiment includes an overlay layer, a decorative layer, and a core layer, it is appreciated that the layering pattern may be varied, somewhat, without departing from the spirit of the present disclosure. For example, it is appreciated that the overlay layer could be removed in the event the intended function of the surfacing allows for its removal.

As with the prior embodiment, the replacement of traditional kraft paper with liner kraft paper offers a number of advantages that include both purely commercial benefits and environmental benefits reducing the carbon footprint associated with the production of surfacing materials. As those skilled in the art can appreciate liner kraft paper differs from traditional kraft paper in that it does not saturate with resin in the same manner that traditional kraft paper saturates with resin. While this characteristic of liner kraft will require the creation of a resin system capable of impregnating liner and grade kraft during the paper making process, the replacement offers a number of advantages, including the fact that such and embodiment will eliminate the dependency on saturating kraft manufacturers, allows will smart to source from the commodity liner kraft market, potentially eliminates the phenolic treating process at Wilsonart, and potentially eliminate formaldehyde based phenolic resins. In addition, the replacement of traditional kraft paper with liner kraft paper will result in the potential for the closure of phenolic treating and collation, which is known to have a high environmental impact and requires a substantial number of workers to ensure proper processing.

The decorative engineered surface 400 is manufactured by first preparing the resin impregnated decorative layer 404 and the liner kraft paper 402a. The resin impregnated decorative layer 404 and resin impregnated core layer 402 are layered to form a laminate lay-up 412, and the laminate lay-up 412 is heated and pressed to consolidate and cure the decorative engineered surface 400.

In accordance with an embodiment of the present disclosure, the decorative engineered surface 400 includes an overlay layer 407, a decorative layer 404, and a core layer 402 comprised of a single sheet of liner kraft paper 402a. It should be appreciated, however, that the layering pattern may be varied, somewhat, without departing from the spirit of the present disclosure.

The overlay layer 407 is preferably a melamine impregnated paper layer. The overlay layer 407 is preferably manufactured from a low basis weight transparent sheet impregnated with resin, for example, melamine. The resin impregnated overlay layer 407 is subsequently dried, partially cured and finally cut into sheets. While the paper may exhibit opaque properties prior to heating and pressing, the overlay layer 407 in the final fabricated decorative engineered surface 400 is preferably transparent to permit viewing of the decorative layer 404 positioned directly beneath the overlay layer 407.

The decorative layer 404 is comprised of a conventional decorative sheet positioned directly beneath the overlay layer 407. When the decorative engineered surface is fully heated and pressed, as will be discussed in detail below, the overlay layer 407 becomes translucent, fully exposing the decorative layer 404. The decorative layer 404 is chosen from a wide array of sheets. For example, the decorative layer 404 may be a solid color (for example, white) or may include an aesthetically appealing pattern.

The overlay layer 407 and the decorative layer 404 also dictate the surface characteristics of the final decorative engineered surface. For example, the composition of the overlay layer 407 and decorative layer 404 dictate the decorative engineered surface's resistance to chemical agents, heat, light, shock, and abrasion.

As discussed above, the decorative layer 404 is comprised of a sheet of decorative paper. The decorative paper may be treated with resin or left untreated.

As to the situation where the decorative sheet is treated with a resin, the decorative sheets are commonly manufactured from high quality 60-205 grams/meter², pigment filled, alpha cellulose paper impregnated with a water alcohol or water solution of melamine-formaldehyde resin. The decorative paper, in accordance with an embodiment of the present disclosure, is impregnated with a resin content of approximately 50% or greater. The resin impregnated decorative sheets are subsequently dried, partially cured, and finally cut into sheets. The pigment filled, alpha cellulose paper of the decorative sheet may include a solid color, a decorative design, or a roto-gravure reproduction of natural materials, such as, wood, marble, leather, etc. The aesthetic characteristics of the cellulose paper are revealed as the decorative engineered surface's decorative design upon completion of the decorative engineered surface.

As to the situation where the decorative sheet is untreated, the decorative layer 404 is comprised of a sheet of decorative paper manufactured from high quality 60-205 grams/meter², pigment filled, alpha cellulose paper. The pigment filled, alpha cellulose paper of the decorative sheet may include a solid color, a decorative design, or a roto-gravure reproduction of natural materials, such as, wood, marble, leather, etc. The aesthetic characteristics of the cellulose paper are revealed as the decorative engineered surface's decorative design upon completion of the decorative engineered surface.

The core layer 402 is preferably comprised of a single sheet of relatively thick liner kraft paper 402a. The liner kraft paper 402a has a very heavy basis weight sheet of approximately 400 gsm. The liner kraft paper 402a is impregnated with an epoxy acrylic or a urethane acrylic (also referred to herein as the acrylate mixture). The liner kraft paper 402a is impregnated with modified with a resin treatment, preferably applied to only one side (that is, the bottom side) of the kraft paper.

In accordance with one embodiment, an epoxy acrylic or a urethane acrylic (also referred to herein as the acrylate mixture) is applied to the bottom surface of the liner kraft paper 402a. First, the epoxy acrylic or urethane acrylic (which is ultimately cured) is laid, or otherwise applied, upon the liner kraft paper 402a and the epoxy acrylic or a urethane acrylic is irradiated with UV-radiation to a partially cure the acrylate mixture. The acrylate mixture is completely cured during the heating process when the decorative engineered surface is pressed and heated as described above. The epoxy acrylic or urethane acrylic is preferably applied to the liner kraft paper 402a by a roller.

In accordance with another embodiment, the bottom portion of the liner kraft paper 402a is impregnated with phenol-formaldehyde resin and is B-stage cured.

Once the appropriate layers of the decorative engineered surface 400 are formed, the sheets are stacked in a conventional manner. A first laminate lay-up 412 as described above is then stacked with a second laminate lay-up 412′ with the second sides of the bottom second resin impregnated core layers 402, 402′ positioned in a facing relationship. The first and second laminate lay-ups 412, 412′ are then placed between steel press plates 450 with the overlay layers 407 of the respective first laminate lay-up 412 and the second laminate lay-up 412′ in direct contact with the steel press plates 450. The laminate stacks are then subjected to temperatures in the range of 121° C.-160° C., preferably 131° C., and pressure of about 56.24 kg/cm²-112.48 kg/cm², preferably 85 kg/cm², for a time sufficient to consolidate the laminate and cure the resins (generally about 25 minutes to an hour). The decorative engineered surface 400, 400′ are then cooled for approximately 10 minutes under pressure before it is ready for further processing in preparation for its use in the manufacture of various products.

While specific temperatures, pressures and times are described above, it should be appreciated that a variety of pressing techniques may be used without departing from the spirit of the present disclosure.

The pressure and heat force the resin in the paper sheets to flow, cure and consolidate the sheets into a unitary laminated mass. Generally, more than one decorative engineered surface is formed at one time.

### Embodiment 5

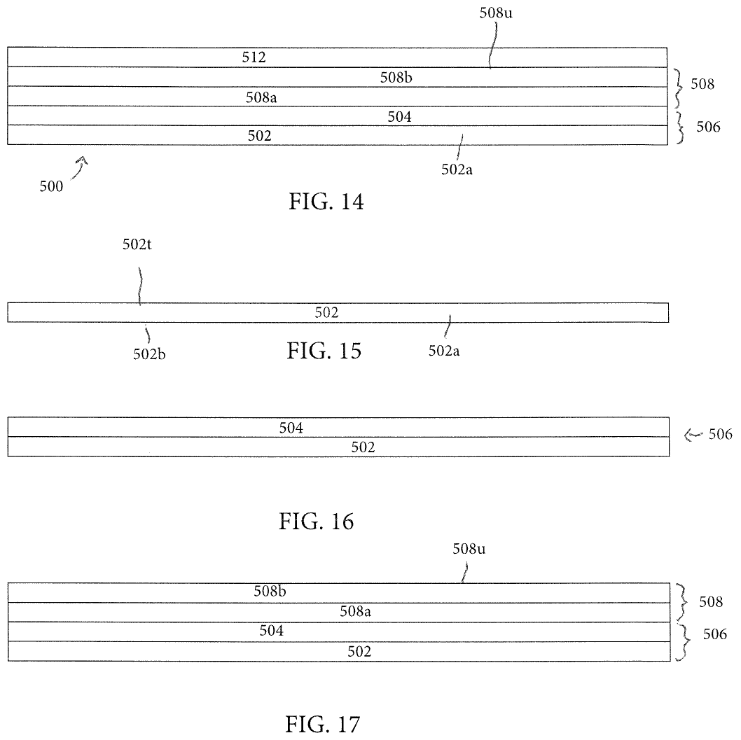

In accordance with a fifth embodiment, as shown with reference to FIGS. 14-17, the decorative engineered surface 500 makes use of a core layer 502 comprised of a single sheet of resin impregnated liner kraft paper 502a, which is, a liner kraft paper having a very heavy basis weight of approximately 400 gsm. This embodiment relies upon a combination of digital printing and various coatings used in conjunction with a core layer of a single sheet of resin impregnated liner kraft paper to produce a durable, cost-effective, and aesthetically pleasing decorative engineered surface.

As briefly mentioned above, the decorative engineered surface 500 includes a core layer 502 of a single sheet of resin impregnated liner kraft paper 502a. Because of the inherent characteristics of the resin impregnated liner kraft paper 502a, no pretreatment is required as the resin impregnated liner kraft paper core layer 502 is highly receptive to digital printing using UV inks. It is also appreciated that water-based inks can also be used, although the clarity may not be as good as that achieved with UV inks. The decorative surfacing 504 is, therefore, applied to resin impregnated liner kraft paper core layer 502 by digital printing (using digital printing techniques) to produce a printed core layer 506 that combines the characteristics of the core layer 502 (that is, the resin impregnated liner kraft paper 502a) with the decorative surfacing 504 (that is, the digitally printed surface the is ultimately protected by a topcoat layer as discussed below).

The utilization of the resin impregnated liner kraft paper core layer 502 on which the decorative surfacing 504 is directly printed results in substantial decrease in environmental impact when one considers such a manufacturing technique no longer requires boilers. regenerative thermal oxidizer (RTO), and phenolic treaters. The decorative engineered surface 500 also eliminates the energy required to press traditional high pressure decorative laminate.

The topcoat layer 508 is applied to the printed resin impregnated liner kraft paper core layer 506 to provide scratch resistance and other physical properties. In accordance with a preferred embodiment, and as discussed above in conjunction with another embodiment, the topcoat layer 508 includes a clear hot melt polyurethane layer 508a followed by a clear UV cured acrylic topcoat layer 508b.

As with the embodiments discussed above, the core layer 502 is preferably a single sheet of relatively thick liner kraft paper 502a. The liner kraft paper 502a has a very heavy basis weight sheet of approximately 400 gsm. The liner kraft paper 502a is impregnated with an epoxy acrylic or a urethane acrylic (also referred to herein as the acrylate mixture) and cured prior to printing. The liner kraft paper 502a is impregnated with modified with a resin treatment, preferably applied to only one side (that is, the bottom side) of the kraft paper.

With reference to the embodiment disclosed with reference to FIGS. 14-17, the manufacture of a decorative engineered surface 500 is disclosed. After the top and bottom surfaces 502t, 502b of the resin impregnated liner kraft paper core layer 502 are brushed clean, the top surface 502t of the resin impregnated liner kraft paper core layer 502 is digitally printed with UV inks. As discussed above, water-based inks may also be used, and where it is desired to use water-based inks, it may be advantageous to treat the resin impregnated liner kraft paper core layer 502 with a priming layer to prepare the resin impregnated liner kraft paper for printing with the water-based inks.

The resin impregnated liner kraft paper core layer 502 is printed digitally using a scanning or single-pass digital printer. As discussed above, UV ink or water-based ink may be used. Where UV ink is employed, the printing is followed by UV curing as is known in the art. Where water-based ink is employed, the printing is followed by a drying process as is known in the art.

Once the resin impregnated liner kraft paper core layer 502 is printed, that is, the printed core layer 506 is formed, a topcoat layer 508 is applied over the UV inks, that is, the topcoat layer 508 is applied to an upper surface of the printed core layer 506.

The topcoat layer 508 in accordance with one embodiment includes a first topcoat layer 508a of clear hot melt polyurethane and a second topcoat layer 508b of clear UV cured acrylic. The coat weight of the clear hot melt polyurethane first topcoat layer 508a determines various functional characteristics of the final product, and these characteristics are ultimately balanced in determining the coat weight of the clear hot melt polyurethane first topcoat layer 508a applied to the printed resin impregnated liner kraft paper core layer 506. In particular, increased coat weight will result in improved impact resistance and an increased resistance to abrasion. It is also appreciated that the hot melt polyurethane may contain aluminum oxide to enhance wear and scratch resistance. Thereafter, a clear UV-cured acrylic second topcoat layer 508b is applied to the clear hot melt polyurethane first topcoat layer 508a. The resulting product is fully cured, and a protective film 512 is applied to the upper surface 508u thereof so as to cover the topcoat layer 508. The decorative engineered surface 500 is then ready for use.

In accordance with another embodiment, the topcoat is an epoxy acrylate (EA) resin. Such resins are known to exhibit good integrated performance such as outstanding adhesion, non-yellowing, hardness, mechanical properties, and chemical resistance. Where epoxy acrylate resins are used, the epoxy acrylate resin can be extended by epoxidized oil and or Lignin derivatives of Eugenol.

The decorative engineered surface 500 described above may be secured to other substrates where greater support and rigidity are desired. For example, substrates to which the decorative surfacing material of the present invention may be secured include a pre-cured plastic laminate, such as glass fiber-reinforced thermoset polyester resin laminates and the like; polyvinyl chloride materials; polyolefinic materials; wood products, such as hardboard, wood waste or particle boards, plywood and the like; mineral-based boards, such as, cement-asbestos board, sheetrock, plasterboard, and the like; or a combination of substrates.

It is also appreciated that texturing may be applied to the decorative surfacing material via the application of a textured layer to the top surface of the vulcanized fiber core layer prior to printing. Thereafter, printing, the topcoat layer, and the protective films are applied as discussed above. Where texturing is desired, such a texturing layer is applied prior to printing and preferably in a manner as disclosed in U.S. Pat. No. 9,199,428, entitled “MULTI-LAY ADDITIVE TEXTURE LAMINATES AND METHODS,” which is incorporated herein by reference. Briefly, the methodology of the '428 patent provides for the production of a multi-layer additive texture high-definition image. The method requires constructing a build layer, wherein the build layer is comprised of one or more build levels, and each of the build levels includes a surface having one or more heights. The heights are varied in correspondence with an image that is to be subsequently printed upon the primed and textured core layer. By layering in this manner, a three-dimensional textured surface is achieved.

The methodology of the '428 patent employs computers in implementing the method for creating high-definition textured surfacing material. In accordance with this element of the methodology of the '428 patent, a surfacing material image is received and a build value is assigned to each of the one or more image properties in the surfacing material image. The build values relate to a texture, specific to the surfacing material image. These build values are applied in the creation of the build layer discussed above.

### CONCLUSION

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by appended claims.

While the preferred embodiments have been shown and described, it will be understood that there is no intent to limit the invention by such disclosure, but rather, is intended to cover all modifications and alternate constructions falling within the spirit and scope of the invention.

1. A decorative engineered surface having a has a thickness of 0.50 mm to 1.00 mm, comprising:
a core layer; and
a decorative layer.

2. The decorative engineered surface according to claim 1, wherein the decorative layer comprises melamine impregnated decorative paper, real wood veneer, thin slate, metallics, digitally printed surface, foils, or polyurethane.

3. The decorative engineered surface according to claim 1, wherein the core layer comprises a vulcanized sheet and decorative surfacing defining the decorative layer comprises digital printing.

4. The decorative engineered surface according to claim 3, wherein the decorative layer further comprises a topcoat layer comprising a melt polyurethane layer followed by a clear UV cured acrylic coating layer.

5. The decorative engineered surface according to claim 3, wherein the decorative layer further comprises a topcoat layer comprising an epoxy acrylate resin.

6. The decorative engineered surface according to claim 1, further including an overlay layer positioned over the decorative layer.

7. The decorative engineered surface according to claim 6, wherein the core layer comprises a vulcanized sheet.

8. The decorative engineered surface according to claim 7, wherein the overlay layer comprises a melamine impregnated paper layer and the decorative layer comprises a decorative sheet positioned directly beneath the overlay layer.

9. The decorative engineered surface according to claim 8, wherein the decorative sheet comprises pigment filled, alpha cellulose paper impregnated with a water alcohol or water solution of melamine-formaldehyde resin.

10. The decorative engineered surface according to claim 8, wherein the decorative sheet comprises unimpregnated pigment filled, alpha cellulose paper.

11. The decorative engineered surface according to claim 6, wherein the core layer comprises plural sheets of liner kraft paper impregnated with is an epoxy acrylic or a urethane acrylic and the overlay layer is a melamine impregnated paper layer.

12. The decorative engineered surface according to claim 11, wherein the decorative layer comprises a decorative sheet positioned directly beneath the overlay layer.

13. The decorative engineered surface according to claim 12, wherein the decorative sheet comprises pigment filled, alpha cellulose paper impregnated with a water alcohol or water solution of melamine-formaldehyde resin.

14. The decorative engineered surface according to claim 12, wherein the decorative sheet comprises unimpregnated pigment filled, alpha cellulose paper.

15. The decorative engineered surface according to claim 6, wherein the decorative layer comprises a resin impregnated decorative sheet and the core layer comprises a single sheet of resin impregnated liner kraft paper.

16. The decorative engineered surface according to claim 15, wherein the liner kraft paper is impregnated with an epoxy acrylic or a urethane acrylic.

17. The decorative engineered surface according to claim 16, wherein the epoxy acrylic or the urethane acrylic is applied to only a bottom surface of the liner kraft paper.

18. The decorative engineered surface according to claim 1, wherein the core layer comprises a single sheet of resin impregnated liner kraft paper and decorative surfacing defining the decorative layer comprises digital printing.

19. The decorative engineered surface according to claim 18, wherein the decorative layer further comprises a topcoat layer comprising a melt polyurethane layer followed by a clear UV cured acrylic coating layer.

20. The decorative engineered surface according to claim 18, wherein the decorative layer further comprises a topcoat layer comprising an epoxy acrylate resin.
